(19) United States
(12) Patent Application Publication
(10) Pub. No.: US 2002/0186203 A1
(43) Pub. Date: Dec. 12, 2002

(54) Wireless remote control device for notebook computers

(76) Inventor: Yu-Fu Huang, Taoyuan (TW)

Correspondence Address: RABIN & BERDO, P.C., 1101 14th Street N.W., Suite 500, Washington, DC, 20005, US

(21) Appl. No.: 10/084,156

(22) Filed: Feb. 28, 2002

(30) Foreign Application Priority Data
Jun. 6, 2001 (TW) 90209421

(51) Int. Cl. G09G 5/08; G09G 5/00

(52) U.S. Cl. 345/157

(57) ABSTRACT

A wireless remote control device for notebook computers with the design of a touch pad and a glide pad is provided. On one hand, the user is allowed to control the power switch of the notebook computer providing security protection for the notebook computer by means of the touch pad; while on the other hand, the user can control the display panel pointer of the notebook computer by means of the glide pad facilitating convenience of operation.

This application incorporates by reference Taiwanese application Serial No. 90209421, Filed Jun. 6, 2001.

### BACKGROUND OF THE INVENTION

1. Field of the Invention

The invention relates in general to a wireless remote control device, and more particularly to a wireless remote control device for notebook computers.

2. Description of the Related Art

The computer has become an indispensable appliance for people living in an age with rapid growth in information and advance in technology. Computers with the feature of fast information processing have benefited the public a lot. However, a large-sized and clumsy computer is inconvenient and portable unfriendly to the user. Therefore, a portable and compact notebook computer, which is more efficient and timesaving to the user, has come to the fore. The configuration of the notebook computer will be disclosed below.

Referring to FIG. 1, a three-dimensional schematic diagram of a conventional notebook computer is illustrated. In FIG. 1, the notebook computer 100 comprises a base unit 102 and a display 104, wherein the display 104, which is jointed to the base unit 102 using a pivotal spindle 106, can close to and open from the base unit 102 via the pivotal spindle 106. Of which, a chamber 107 situated in the display 104 is equipped with a display panel 108 such as a Liquid Crystal Display (LCD) on which signals are displayed. The base unit 102 further comprises a base unit's top face 110, a keyboard 112, a touch pad 114 and a power switch device 116. Of which, the keyboard 112 and the touch pad 114 are situated at openings 118 and 120 in the base unit's top face 110; the keyboard 112 is used for the user to input operation signals with; and the touch pad has the mouse function. For example, when the user touches the touch pad 114 with his or her fingers, the touch pad 114 will contact a control circuit (not shown in the diagram) sending a control signal to the notebook computer 100 controlling a pointer (not shown in the diagram) on the display panel 108. Apart from this, the power switch device 116 with which the user switches the power of the notebook computer in the direction of the arrow is situated at an opening 124 in a base unit's side face 122 of the base unit 102.

Despite a notebook computer does benefit people a lot due to its portability and convenience, a notebook computer with stored data is apt to be stolen and misused by evil-intentioned people. Since prevention is better than cure, how to adopt an adequate security measure is indeed an important issue. On the other hand, during the discussion in a meeting, the presenter can present his or her materials more clearly if a notebook computer is connected to a projector to enlarge and project the presentation materials onto the wall so that the audience can see the materials more easily and clearly. Presentation materials are usually lengthy and cover several pages. In order to select the needed page, the presenter has to be close to the notebook computer so he or she can touch the touch pad to control the pointer which is not only inconvenient but also a waste of a time. As a consequence, to control the pointer by touching the touch pad of a notebook computer always ends up with an intermittent presentation, which interrupts with the audience's train of thoughts greatly. It will help to achieve a continuance of presentation if the presenters have a carry-on pointer control with them.

### SUMMARY OF THE INVENTION

It is therefore an object of the invention to provide a wireless remote control device for notebook computers. The design of the touch pad and the glide pad of the wireless remote control device according to the invention allows the user to switch the power of notebook computer by means of the touch pad achieving protection and security for notebook computers. Besides, the user can remotely control the movement of the pointer displayed on the display panel beyond the limitation of space overstepping the conventional touch pad design, which is limited to the use of a notebook computer only. It is indeed very convenient to the user.

According to the object of the invention, a remote control device used to output a control signal to a notebook computer is provided. The remote control device comprises a touch pad and an emission device, wherein the touch pad used to produce a control signal is situated on the top face of the remote control device while the emission device receives the control signal and outputs it to the notebook computer. Of which, the control signal is used to control the power switch of the notebook computer.

According to another object of the invention, a remote control device used to output a control signal to a notebook computer is provided. The remote control device comprises a glide pad and an emission device, wherein the glide pad used to produce the control signal is situated on the top face of the remote control device while the emission device receives the control signal and outputs it to the notebook computer. Of which, the control signal is used to control the display panel pointer of the notebook computer.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows a three-dimensional schematic diagram of a conventional notebook computer; and

FIG. 2 shows a three-dimensional schematic diagram of a remote control device of a notebook computer according to a preferred embodiment of the invention.

### DESCRIPTION OF THE PREFERRED EMBODIMENT

A remote control device appropriate for a notebook computer is designed in the invention. The remote control device can be equipped with a touch pad and a glide pad. Of which, the glide pad is situated on the touch pad while the touch pad provides the user with power switch function of the notebook computer preventing others from opening the notebook computer and stealing the stored data so that a security measure is assured. Furthermore, the glide pad with which the user controls the display panel pointer of the notebook computer allows the user to control the pointer in a distance as if the remote control device was a wireless mouse. As for the practical application of the remote control device is disclosed below in a preferred embodiment.

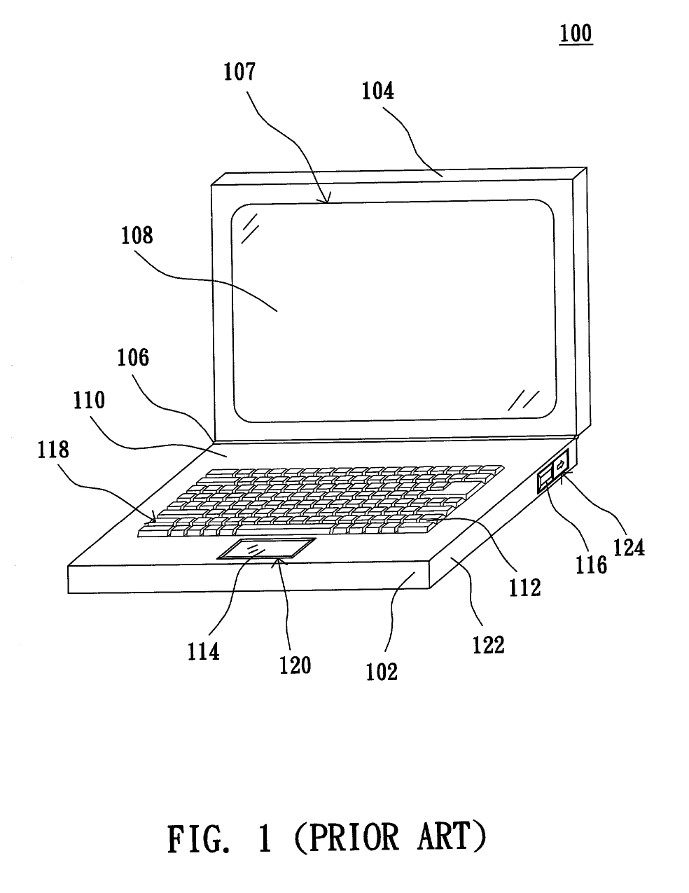

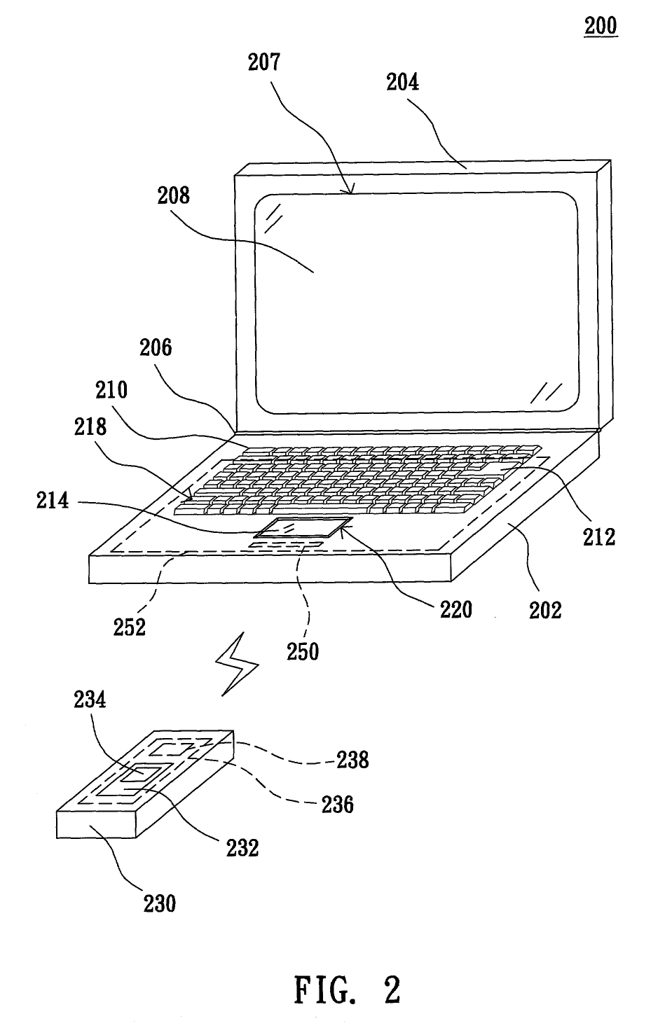

Referring to FIG. 2, a three-dimensional schematic diagram of a remote control device of a notebook computer according to a preferred embodiment of the invention is illustrated. In FIG. 2, a notebook computer 200 comprises a base unit 202 and a display 204, wherein the display 204 is jointed to the base unit 202 via a pivotal spindle 206 so that the display 204 can close to and open from the base unit 202 via the pivotal spindle 206. Of which, a display panel 208, a Liquid Crystal Display (LCD) for instance, on which signals are displayed is situated in a chamber 207 of the display 204. Whereas the base unit 202 comprises a base unit's top face 201, openings 218 and 220, a keyboard 212 with which the user inputs operation signals as well as a touch pad 214. Since the touch pad 214 has the same function like that of the touch pad 114 in FIG. 1 so the same explanation will not be repeated here.

A wireless remote control device 230 comprising a touch pad 232, a glide pad 234, a control circuit 236 and an emission device 238 is particularly designed in the invention. Whereas the touch pad 232, which is situated on the top face of the wireless remote control device 230, contacts the control circuit 236 when touched by the user, producing a first control signal to control the power switch of the notebook computer. Of which, the glide pad 234, which is situated on the touch pad 232, contacts the control circuit 236 when touched by the user, producing a second control signal to control the pointer (not shown in this diagram) of the display panel 208. The emission device 238 being electrically connected to the control circuit 236 receives the first and the second control signals from the control circuit 236 and then transmits the two signals to a receiving device 250 of the base unit 202. Whereas the control circuit 252 of the base unit 202, which is electrically connected to the receiving device 205, receives the first and the second control signals from the receiving device 250. The emission device 238 can be a radio frequency (RF) emission device or an infrared emission device while the receiving device 250 can be a radio frequency (RF) receiving device or an infrared receiving device.

The touch pad 232 can be a plurality of buttons and a finger print platform, wherein the buttons are used for the user to enter codes with. The user will be allowed to use the notebook computer 200 if the codes entered prove to be correct. Whereas the finger print platform has already memorized the user's fingerprints by which the remote control device identifies the user. The user will be allowed to use the wireless remote control device 230 only if the identification proves to be correct. Besides, the glide pad 234 has the same function like that of the touch pad 214 of the notebook computer 200, which is equivalent to a wireless mouse. By this arrangement, the presenter can easily and directly turn to the desired pages of his or her materials using the touch pad 234 of the invention, which is indeed very handy and convenient during discussion in a meeting.

A wireless remote control device for notebook computers is disclosed in the preferred embodiment according to the invention. The design of touch pad and the glide pad of the wireless remote control device according to the invention allows the user to switch the power of notebook computer by means of the touch pad achieving protection and safety effect for the notebook computer. Besides, the user can remotely control the movement of the pointer displayed on the display panel overstepping the conventional design of touch pad, which is limited to the use of a notebook computer only. The design transcends the limitation of space and provides the user with convenience of operation.

While the invention has been described by way of example and in terms of the preferred embodiment, it is to be understood that the invention is not limited to the disclosed embodiment. Any one who is familiar with the technology of the invention can make varied adjustments and modifications without violating the spirit and scope of the invention. For example, the remote control device of the invention can be further equipped with at least one hot key controlling the power switch of the CD-ROM of the notebook computer. By means of the hot key, the user can easily close and open the CD-ROM, choose and have his or her favorite music played in the CD-ROM. Therefore, the scope of protection of the invention is defined in the appended claims; and it is to be understood that invention is intended to cover various modifications and similar arrangements and procedures, and the scope of the appended claims therefore should be accorded the broadest interpretation so as to encompass all such modifications and similar arrangements and procedures.

What is claimed is:

1. A remote control device used to output a first control signal to a notebook computer, comprising:
a touch pad situated on the top face of the remote control device used to produce the first control signal; and
an emission device used to receive the first control signal and output it to the notebook computer, wherein the first control signal is used to control the power switch of the notebook computer.

2. A remote control device according to claim 1, wherein the touch pad compromises at least one button.

3. A remote control device according to claim 1, wherein the touch pad is a finger print platform.

4. A remote control device according to claim 1, wherein the remote control device is a wireless mouse.

5. A remote control device according to claim 4 further compromising: a glide pad situated on the touch pad used to produce a second control signal controlling a display panel pointer of the notebook computer.

6. A remote control device according to claim 1, wherein the control signal is outputted to a receiving device of the notebook computer.

7. A remote control device according to claim 6, wherein the receiving device is a radio frequency (RF) receiving device.

8. A remote control device according to claim 6, wherein the receiving device is an infrared receiving device.

9. A remote control device according to claim 1, wherein the emission device is an RF emission device.

10. A remote control device according to claim 1, wherein the emission device is an infrared device.

11. A remote control device according to claim 1, further compromises:
a hot key situated on the touch pad used to produce a third control signal controlling a CD-ROM of the notebook computer.

12. A remote control device used to output a first control signal to the notebook computer, wherein the remote control device compromises:
a glide pad situated on the top face of the remote control device used to produce the first control signal; and
an emission device used to receive the first control signal and output it to the notebook computer, wherein the first control signal controls a display panel pointer of the notebook computer.

13. A remote control device according to claim 12, wherein the control signal is outputted to a receiving device of the notebook computer.

14. A remote control device according to claim 13, wherein the receiving device is an RF receiving device.

15. A remote control device according to claim 13, wherein the receiving device is an infrared receiving device.

16. A remote control device according to claim 12, wherein the emission device is an RF emission device.

17. A remote control device according to claim 12, wherein the emission device is an infrared device.

18. A remote control device according to claim 12, further compromises:
a hot key situated on the top face of the remote control device used to produce a third control signal controlling a CD-ROM of the notebook computer.

19. A remote control device used to output a first control signal and a second control signal to a notebook computer, wherein the remote control device compromises:
a touch pad situated on the top face of the remote control device used to produce the first control signal;
a glide pad situated on the touch pad used to produced the second control signal; and
an emission device used to receive the first and the second control signals and output them to the notebook computer, of which, the first control signal controls the power switch of the notebook computer whereas the second control signal controls a pointer on the display panel of the notebook computer.

20. A remote control device according to claim 19, further compromises:
a hot key situated on the top face of the remote control device used to produce a third control signal controlling a CD-ROM of the notebook computer.
